(19) United States
(12) Patent Application Publication
(10) Pub. No.: US 2008/0201112 A1
(43) Pub. Date: Aug. 21, 2008

(54) NETWORK DESIGN METHOD AND SYSTEM THEREFOR

(76) Inventors: Mario Bouchard, Laval (CA); Hugo Charbonneau, St-Laurent (CA)

Correspondence Address: BROUILLETTE & PARTNERS, METCALFE TOWER, 1550 METCALFE STREET, SUITE 800, MONTREAL, QC, H3A-1X6, omitted

(21) Appl. No.: 11/676,322

(22) Filed: Feb. 19, 2007

(51) Int. Cl. G06F 17/50

(52) U.S. Cl. 703/1

(57) ABSTRACT

A computer-implemented method is disclosed for creating a distributed antenna network for use in designing a generally wireless communications network. The method includes the placing and interconnecting, on a design screen canvas, of network components, selected from a components database stored in a computer system, with several signal source systems having different parameters. The method also generally includes the verification of the compatibility of the different interconnected components and signal sources and the notification of incompatibility if any. The method further generally includes the calculation, at each interconnection, of the uplink and the downlink link budgets for each signal source. The method also includes the displaying of graphical representations of the estimated propagation of the signals according to the parameters of each signal source. A computer system for supporting the method is also disclosed.

### CROSS-REFERENCE TO RELATED APPLICATIONS

The present patent application claims the benefits of commonly assigned U.S. patent application Ser. No. 10/744,018, filed on Dec. 24, 2003 and entitled “System and Method for Designing a Communications Network” and which is incorporated herein by reference.

### FIELD OF THE INVENTION

The present invention concerns wireless communications networks, and more particularly system and method for designing a wireless communications network.

### BACKGROUND OF THE INVENTION

Mobile communications devices, such as cellular telephones, pagers and the like, are now commonplace and are now being used almost more indoor than in vehicles. With the new form factor of cellular phones and the growing demand for wireless data services, the mobile traffic has generally shifted from outdoors to indoors, where typically Radio Frequency (RF) penetration is often limited. To maximize average revenues per users, reduce the percentage number of deactivations and maintain customer satisfaction, wireless operators have to optimize their network and do RF deployment inside buildings using state-of-the-art technologies to improve coverage, data throughput and capacity. In-building RF design is generally very complex, especially nowadays with the advent of multi-carriers and multi-technologies that are requested by the building's owners. These systems can cause serious deterioration of the network if they are not engineered correctly. Moreover, wireless operators may suffer from a lack of knowledge and expertise and may not take full advantage of their in-building networks.

Several types of software and systems have been developed to address the problems of in-building network designs, a few examples of which are illustrated as follows:

U.S. Pat. No. 6,625,454, issued Sep. 23, 2003, to Rappaport et al. for “Method and System for Designing or Deploying a Communications Network which Considers Frequency Dependent Effects”;

U.S. Pat. No. 6,336,035, issued Jan. 1, 2002, to Somoza et al. for “Tools for Wireless Network Planning”;

U.S. Pat. No. 6,356,758, issued Mar. 12, 2002, to Almeida et al. for “Wireless Tools for Data Manipulation and Visualization”;

U.S. Pat. No. 6,317,599, issued Nov. 13, 2001, to Rappaport et al. for “Method and System for Automated Optimization of Antenna in 3-D”;

U.S. Pat. No. 6,199,032, issued Mar. 6, 2001, to Anderson for “Presenting an Output Signal Generated by a Receiving Device in a Simulated Communication System”; and

U.S. Pat. No. 6,119,009, issued Sep. 12, 2000, to Baranger et al. for “Method and Apparatus for Modeling the Propagation of Wireless Signals in Buildings”.

Of course, the foregoing list is not exhaustive and other systems and methods exist in the art. Nevertheless, the aforesaid methods and systems generally only perform the prediction part of a network design. Currently, other separate software tools such as Word™, Excel™, Visio™ and AutoCAD™ are often required to perform subsequent design operations. These methods tend to be error prone, complicated and not standard from one designer to another.

With the aforesaid methods, often the steps include the use of a) prediction software or data collection in the field followed by b) antenna network design using Excel™, Word™, Visio™, and the like. When the designer chooses to use prediction software in step a), errors are often included since it is based on theoretical modeling. In this case, often the designer will choose to do the data collection in the field as well to correlate his results. However, step b) still has the problem of combining multiple separate tools which brings standardization problems and design errors. Moreover, when parameters or other data are changed in one of the softwares, they generally need to be changed manually in all the other softwares, which can be tedious and error-prone.

In addition, many of the systems are complex and require multiple measurements to be taken and verified by engineers located in the wireless network. Often the measurements are not based on actual facts about the environment, but are based on theoretical models, which would compromise the accuracy of the final design. None of the aforesaid designs appear to be integrated into a single software package that is accessible from a personal computer.

Thus there is a need for an improved software and system for designing wireless communications networks.

### SUMMARY OF THE INVENTION

The present invention reduces the difficulties and disadvantages of the prior art by providing a software, and a computer system thereof, which enables the wireless designer to use a single design tool to design a network, adjust the parameters, estimate and/or evaluate the propagation of the signals, evaluate the costs, prepare the installation plans, prepare the network elements lists and print all the documentation necessary for an in-building wireless communications network.

Preferably, the software supports multiple sources of signal such as multi-bands and multi-technologies on multiple systems on the same design. The software also preferably automatically calculates downlink and uplink link budgets at each connection and for each signal source on a design screen canvas, which significantly reduces design time and design errors and enables system components incompatibilities to be detected and corrected more rapidly. Advantageously, the present software can calculate downlink and uplink link budgets for one or more parameters such as but not limited to, loss, gain, signal-to-noise ratio, signal-to-interference ratio, etc. Moreover, the present invention can calculate different link budgets for different signal sources.

According to another aspect of the present invention, the design screen canvas advantageously displays representations of network elements such as components, connectors and signal sources and generally enables the designer to connect the components, connectors and signal sources on screen using a user-friendly drag-and-drop technique. Another aspect of user-friendliness is found in the on-screen accessibility of a network elements database. According to the invention, on-screen windows, tool bars and boxes, operatively linked to one or more databases, enable the designer to scroll through list of components, connectors and signal sources in database and to select the desired components, connectors and/or signal sources therefrom. The selected network elements can also be located on a two-dimensional or three-dimensional floor plan to generate the network installation plans.

The network elements database preferably further comprises all the electrical, mechanical, physical, electromagnetic and/or monetary specifications and parameters of all the available network elements in order for the system to take these different specifications and parameters into account during the design of the network.

The network elements database used in the system can also advantageously be located on a central server and shared between multiple users in order for them to design networks according to a coherent set of network elements.

Each network element is also graphically represented, which advantageously enhances the visual impact while increasing the ease of understanding of how the network is constructed.

According to another aspect of the invention, the software allows the designer to navigate between different graphical representations of the network. Hence, the designer can, for example, switch between a schematic representation, a floor plan representation and an installation plan of the network. Still, other graphical representations are possible. Moreover, the software advantageously links all the graphical representations together so that any changes made to a network element in one representation will be passed along and transmitted to the other graphical representations such that all the parameters and computed values (e.g. link budgets, compatibility) are updated accordingly.

In another advantageous aspect of the invention, the designer can generate reports with the components overlaid onto installation plans and produce equipment lists and cost reports containing information based on unit cost and installation cost of each component.

According to an important aspect of the present invention, the software provides the designer with a graphical representation of the predicted propagation of the signals from each signal source simultaneously. Accordingly, each signal from each source is assigned a colour, a symbol or any other differentiating element and the predicted coverage of each signal is displayed according to the colour, symbol or differentiating element. Furthermore, the software generally allows the designer to select and/or enter one or more thresholds in order to display only the signals respecting the threshold or thresholds.

According to this aspect of the invention, the designer can see at a single glance which area is adequately covered by which signal sources. It thus becomes much easier to compare the effectiveness of different signal source technologies and/or different parameters in a particular network environment.

Preferably, the present software is embodied in a computed-implemented method which can be executed on a computer system which comprises all the necessary components such as central processing unit, memory elements (ROM, RAM, hard drives, etc.), input devices (e.g. keyboard, mouse, touchpad, etc.), media readers (e.g. CD-ROM reader, DVD reader, disk drive, etc.), display screen, network cards, etc. The skilled addressee will readily understand that the exact construction of a computer system may substantially vary. The present invention is therefore not limited to any particular computer system.

In any case, the features of the present invention which are believed to be novel will be set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a printout of a designed Distributed Antenna Network (DAN);

FIG. 1a is a representation of a floor plan with a transposed thereon;

FIG. 2 is a computer screenshot of a software suite showing a designed DAN;

FIG. 3 is a block diagram of an embodiment of the software of the present invention;

FIG. 4 is a flow diagram showing a general method of the present invention;

FIG. 5 is a flow diagram showing the steps of a method for defining a project;

FIG. 6 is a flow diagram showing the steps of a method for creating a signal source system;

FIG. 7 is a computer screenshot of a signal source system parameters;

FIG. 7a is a computer screenshot of information about a specific type of source;

FIG. 8 is a flow diagram showing the steps of a method for selecting DAN components from a database before interconnecting the components;

FIG. 9 is a computer screenshot of a database parts editor;

FIG. 9a is a computer screenshot of a modified component in the database;

FIG. 10 is a computer screenshot of components selection from the database;

FIG. 11 is a flow diagram of the steps of selecting a cabling component, connecting the components and verifying the component's compatibility;

FIG. 12 is a computer screenshot of a generated equipment list report;

FIG. 13 is a computer screenshot of a generated cost report;

FIG. 14 is a computer screenshot of a representation of a floor plan with a DAN transposed thereon;

FIG. 15 is a computer screenshot of the floor plan of FIG. 14 with the graphical representation of the predicted coverage of a first signal source;

FIG. 16 is a computer screenshot of the floor plan of FIG. 14 with the graphical representation of the predicted coverage of a second signal source;

FIG. 17 is a computer screenshot of the floor plan of FIG. 14 with the graphical representation of the predicted coverage of a third signal source;

FIG. 18 is a computer screenshot of the floor plan of FIG. 14 with a combination of the graphical representation of the predicted coverage of the first signal source of FIG. 15 and the second signal source of FIG. 16;

FIG. 19 is a computer screenshot of the floor plan of FIG. 14 with a combination of the graphical representation of the predicted coverage of the first signal source of FIG. 15 and the third signal source of FIG. 17;

FIG. 20 is a computer screenshot of the floor plan of FIG. 14 with a combination of the graphical representation of the predicted coverage of the second signal source of FIG. 16 and the third signal source of FIG. 17; and

FIG. 21 is a computer screenshot of the floor plan of FIG. 14 with a combination of the graphical representation of the predicted coverage of the first signal source of FIG. 15, the second signal source of FIG. 16 and the third signal source of FIG. 17.

### LIST OF ABBREVIATIONS

Abbreviations used herein include:

CDMA: Code-Division Multiple Access;

AMPS: Advanced Mobile Phone Service;

GPRS: General Packet Radio Services;

UMTS: Universal Mobile Telecommunications Service;

SMR: Specialized Mobile Radio;

PCS: Personal Communications Services;

DCS: Digital Collection System;

iDEN: Integrated Digital Enhanced Network; and

ISM: Industrial Scientific Medical.

### DETAILED DESCRIPTION OF THE PREFERRED EMBODIMENTS

A novel network design method and its associated computer system will be described hereinafter. Although the invention is described in terms of specific illustrative embodiments, it is to be understood that the embodiments described herein are by way of example only and that the scope of the invention is not intended to be limited thereby.

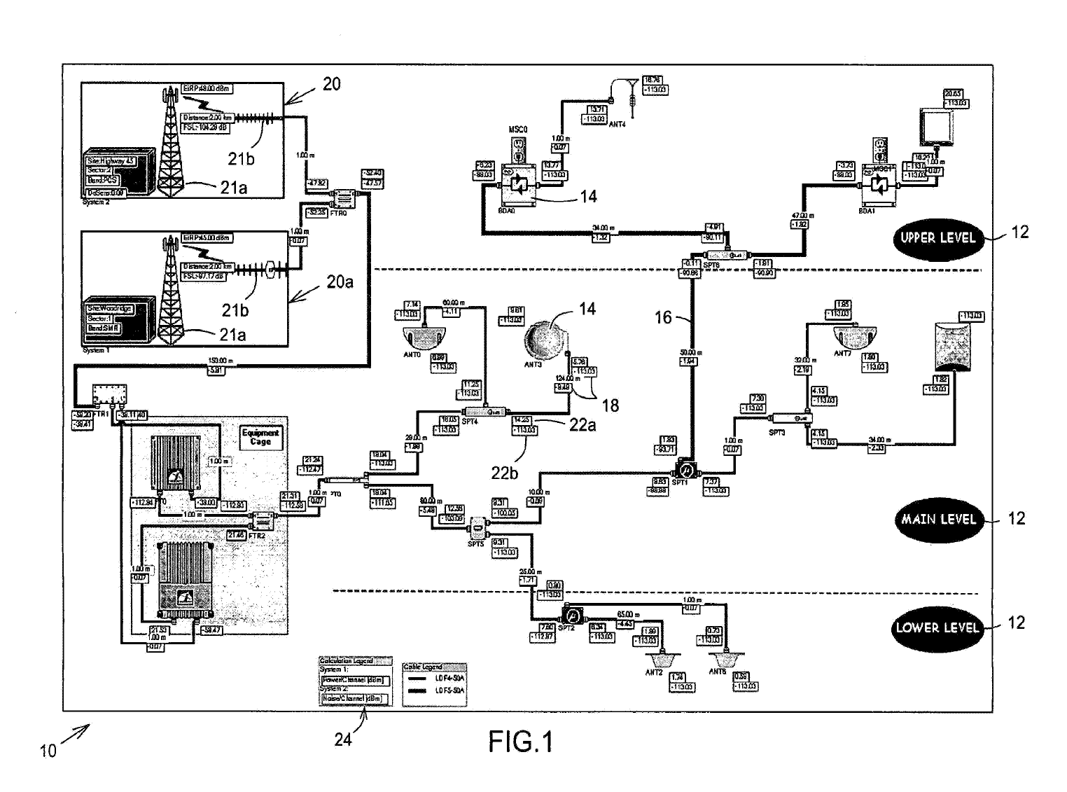

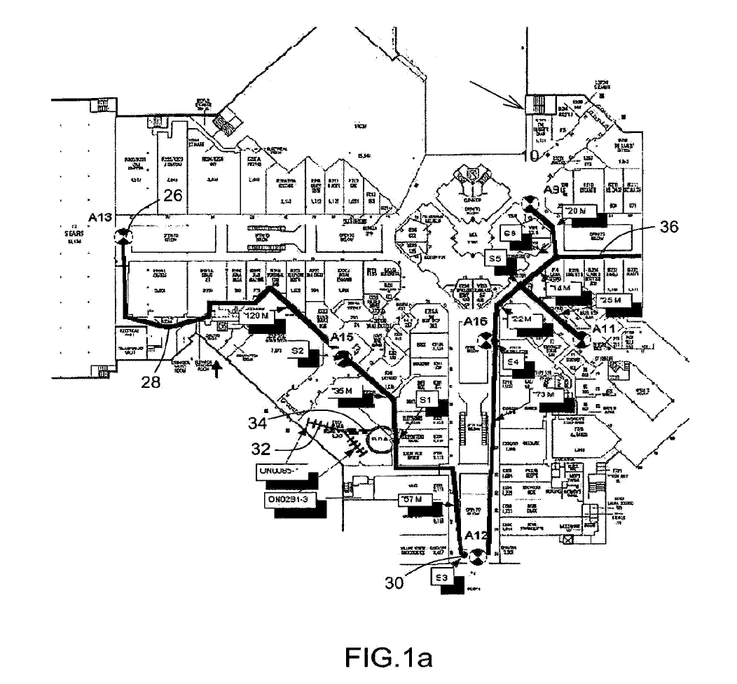

According to the preferred embodiment of the present invention, there is provided a computer-implemented method for creating a distributed antenna network (hereinafter “DAN”), as illustrated in FIG. 1, for use in designing preferably but not exclusively in-building wireless communications network.

The method of the present invention is understandably embodied in a software, stored on a computer-readable media which is run on a computer system. Computer systems are known in the art and therefore only the required computer devices will be recited. In any case, the skilled addressee will know which computer system and computer peripherals should be needed.

Generally speaking, aside from the main computer system (processing unit, memory storage elements, etc.), the present invention generally requires a display screen for providing the graphical representations of the network under development and inputting devices, preferably in the form of pointing devices such as a mouse, trackball, touchpad, etc. Understandably, the pointing device is used to interact with the graphical representations displayed on the display screen.

General Method

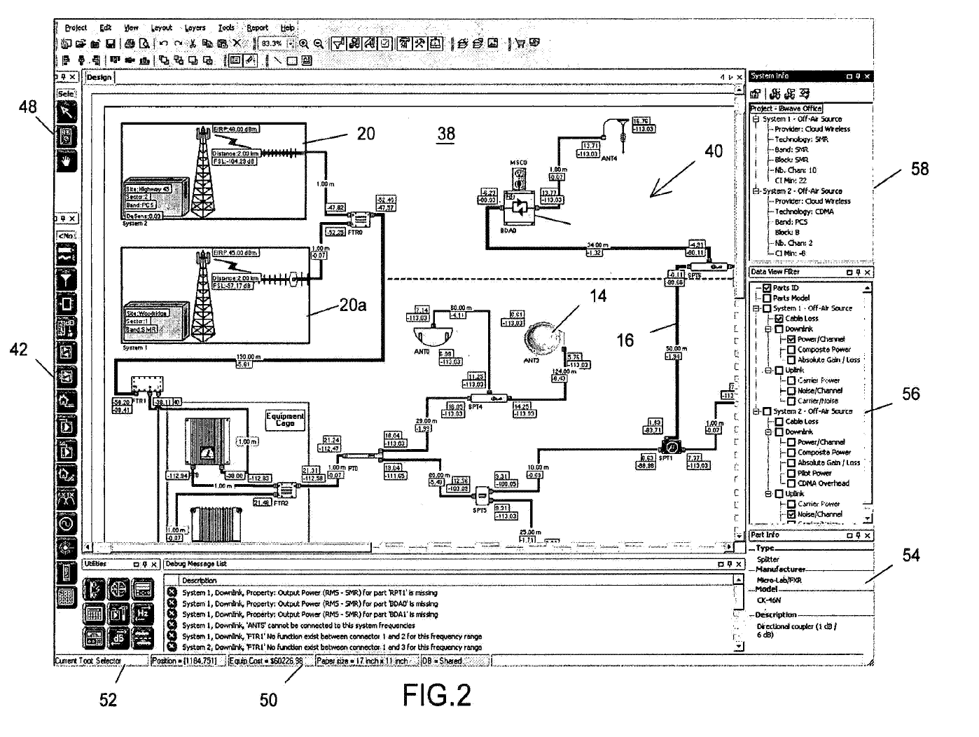

According to the present invention, the method is generally embodied using a design screen canvas 38, as shown in FIG. 2. The design screen canvas 38 is preferably provided on a computer display screen connected to a computer system. As it will be described in more details below, the network 40 designed on the design screen canvas 38 generally comprises signal source systems 20, 20a (for clarity, only two are shown), network components 14 (e.g. antennas, splitters, amplifiers) and cabling components 16.

In the preferred embodiment, the design screen canvas comprises several tool bars such as component tool bar 42 and a selection toolbar 48 and several windows and boxes such as debug window 50, link budget calculation utilities box 52, component information box 54, link budget calculations options 56 and signal source system list 58. Understandably, more or less tool bars, windows and boxes could be provided. The invention is not so limited.

When the designer wishes to design a new network, the design screen canvas 38 will be blank.

Using the pointing device, the network designer can place different network elements 14 onto the design canvas 38. Generally, the designer will place one or more network components 14 such as, but not limited to, splitters, routers, amplifiers, repeaters. These components are generally available through a components database accessible via the design canvas screen 38. Hence, according to the present invention, the designer will select and/or access the component database, select a particular component according to one or more component characteristics and then drag-and-drop the selected component onto the design canvas 38. This step can be repeated as long as components 14 are needed in the network 40. Moreover, the designer may always select and/or access the component database to select additional components 14 if required.

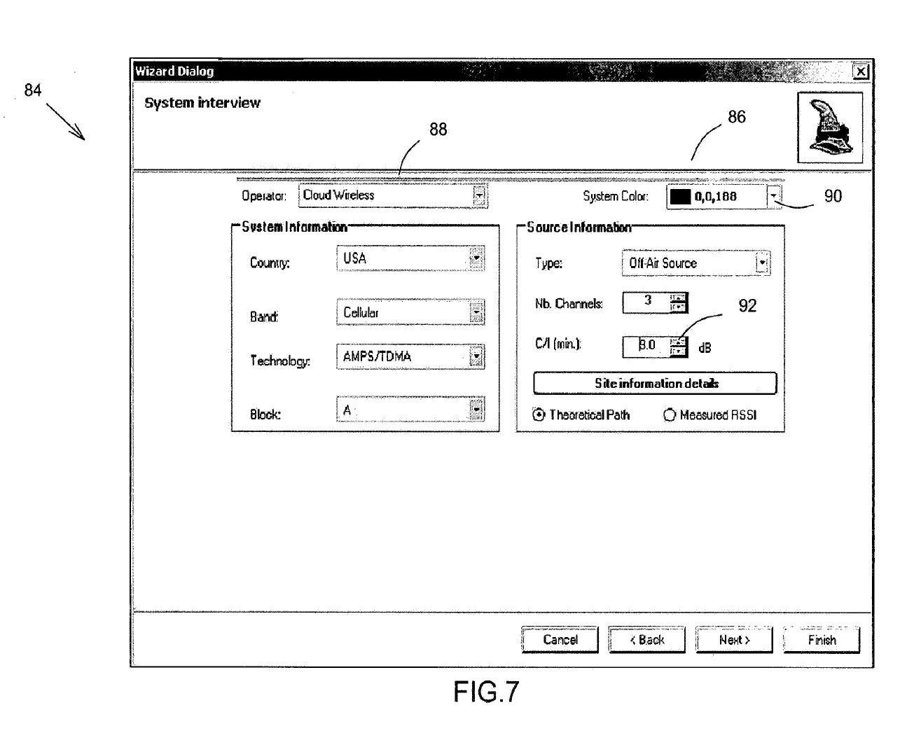

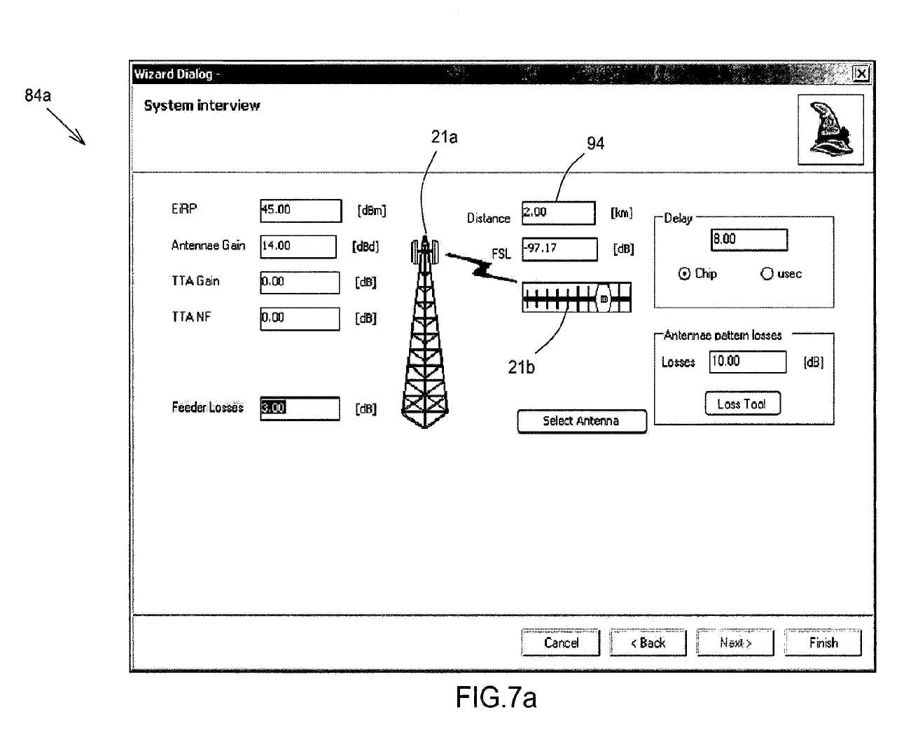

The designer will also place several signal source systems 20 onto the design canvas 38. As for the network components 14, the signal source systems 20 are available through a signal source system database accessible via the design canvas screen 38. The database may be directly accessible through the design canvas 38 or via a separate screen window 84 such as the one shown in FIG. 7. Screen window 84 enables the designer to visualize and modify the signal source system parameters and assign visual properties as system color 86, operator name 88 and the like to the system, using selection from drop down 90 or scroll down menus 92.

In any case, as for the network components 14, the designer will select and/or access the signal source system database, select a particular signal source system 20 according to one or more signal source system parameters and then drag-and-drop the selected signal source system 20 onto the design canvas 38. Understandably, since signal source systems 20 generally provide for a certain level of parameter determination, it is possible for the designer to modify certain parameters such as, but not limited to, antenna gain, antenna distance and feeder losses. Preferably, the determination of the parameter is effected through a special screen such as screen window 84a shown in FIG. 7a. Screen window 84a allows, for example, to set the distance 94 of the antenna 21a of the signal source system 20.

According to an important aspect of the present invention, each signal source system 20 is different from the other signal source systems 20 with respect to at least one parameter.

Once the network components 14 and the signal source systems 20 are placed on the design canvas 38, they are connected together via cabling components 16. The cabling components are available through a cabling database accessible via the design canvas screen 38. Accordingly, the designer will select and/or access the cabling database and then select a particular cabling component 16. Then, on the design canvas 38, the designer will linked two components 14 and/or signal source systems 20 with the cabling component 16. This step is generally effected with the use of the pointing device.

According to the present invention, in order to provide a schematic representation of the network under development, the network components 14, signal source systems 20 and cabling components 16 selected and placed are each represented on the design canvas 38 via graphical representations and/or icons. FIG. 2 shows a screenshot of a design canvas 38 with a network 40 under development represented thereon.

At this point, the skilled addressee will understand that even though the previous steps have been described sequentially, network design is generally an iterative process and thus, it is always possible to add, remove and/or change one or more network components 14, signal source systems 20 and cabling components 16 during the design process.

One of the interesting aspect of the present invention is the step of compatibility verification that follows the interconnection of the network components 14 and signal source systems 20. Thus, when the network components 14 and signal source systems 20 are interconnected, the system will verify if the interconnected network components 14 and/or signal source systems 20 are compatible and/or if the cabling components 16 is compatible with both interconnected network components 14 and/or signal source systems 20. If the system detects incompatibility, an indication thereof will be provided in the debut window 50 preferably provided in the design canvas screen 38. Preferably, the debug window 50 will indicated the location and the nature of the incompatibility. Understandably, the nature of the incompatibility can vary. For example there may be an incompatibility due to incompatible signal source system, incompatible impedance, incompatible voltage, active component saturation, excessive voltage drop, incompatible connector type, etc.

The design method further includes a step wherein the uplink and downlink link budgets are calculated at each interconnection and preferably displayed on the design canvas 38. The nature of the calculated parameter can vary. Accordingly, the designer may decide to calculate the gain or the loss are each interconnection. Other parameters such as power/channel, composite power, absolute gain/loss, noise/channel, mobile power and carrier/noise may also be selected. Understandably, other technology specific parameters are possible. In any case, the design has preferably the freedom the determine which parameter will be calculated for each signal source system.

Though the compatibility verification and the link budgets calculations may be done substantially simultaneously, it is to be understood that if a certain interconnection is incompatible, no link budget will be calculated therefor.

Further to the link budget calculations, additional data, such as cable loss, may be displayed on the design canvas 38 or the software may be adapted to perform customized calculations.

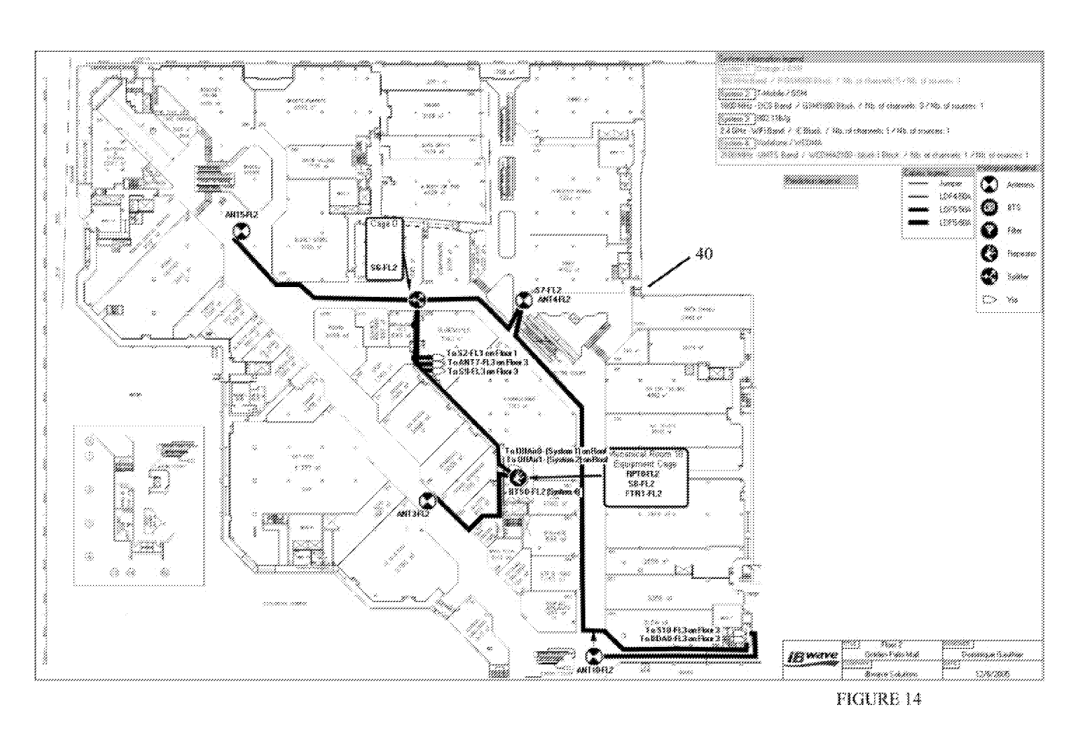

In another important aspect of the present invention, the method further includes the step of transposing the network 40 designed on the design screen canvas 38 onto at least one floor plan representation. Generally, the floor plan representation is a screen different from the design canvas as shown in FIGS. 1a and 14.

As used hereinabove and hereinbelow, the term “floor plan” encompasses both the floor plan of the interior of a building and the floor plan (or ground plan) of an exterior area outside a building. Thus, the term “floor plan” must not be construed as limited to the floor plan of the interior of a building.

Generally speaking, the floor plan representation is a representation of the physical environment into which the network 40 under development will be effectively deployed. Understandably, the environment can be indoor or outdoor or even a combination thereof. In any case, the floor plan representation generally comprises the physical structures present in the environment. Without being limitative in nature, the structures may be walls, doors, windows, trees and other physical obstacles.

According to an important aspect of the present invention, even though the schematic representation and the floor plan representation are shown on distinct screens, the network 40 shown thereon is the same and any changes made to the network 40 shown in one representation will be reflected in the other representations. For example, if an antenna and its accompanying cable is displaced in the floor plan representation, the link budget of the interconnection will be updated in the schematic representation of the design canvas 38. Conversely, if cable 16 is replaced by another type of cable 16 in the schematic representation of the design canvas 16, the cable 16 will also be replaced in the floor plan representation.

Still, the skilled addressee will understand that other graphical representations are possible. Moreover, even though the graphical representations are generally shown in 2 dimensions, one or more graphical representations could be shown in 3 dimensions should it be preferred and found advantageous.

According to an important aspect of the present invention, the method comprises a step wherein the estimated signal propagations of each signal source system 20 of the network 40 are displayed in a superposed fashion over the floor plan. The estimated signal propagations are calculated by taking into account the physical properties (e.g. absorption, reflection, attenuation) of the physical structures (e.g. walls, doors, windows, trees).

In order to differentiate the propagation of each signal source system 20, each signal source system 20 is assigned a differentiating element such as a color or a symbol. Furthermore, in order to keep the floor plan readable when the estimated signal propagations are superposed, it is preferable that only the signals which are under (or over) a certain threshold be displayed. Understandably, the thresholds are determinable by the designer and different signal source system 20 could have different thresholds. The present invention is not so limited.

Referring now to FIGS. 14 to 21, an example of the display of the estimated signal propagations will be described.

Referring to FIG. 14, the network 40 designed on the design screen canvas 38 is shown in a floor plan of a building. In FIG. 14, no estimated signal propagation is shown. Still, the skilled addressee will note that the network 40 represented in the floor plan of FIG. 14 effectively comprises four different signal sources, as shown in the systems information legend in the upper right corner of the floor plan. Hence, the estimated propagation will generally be tested for the four signal sources.

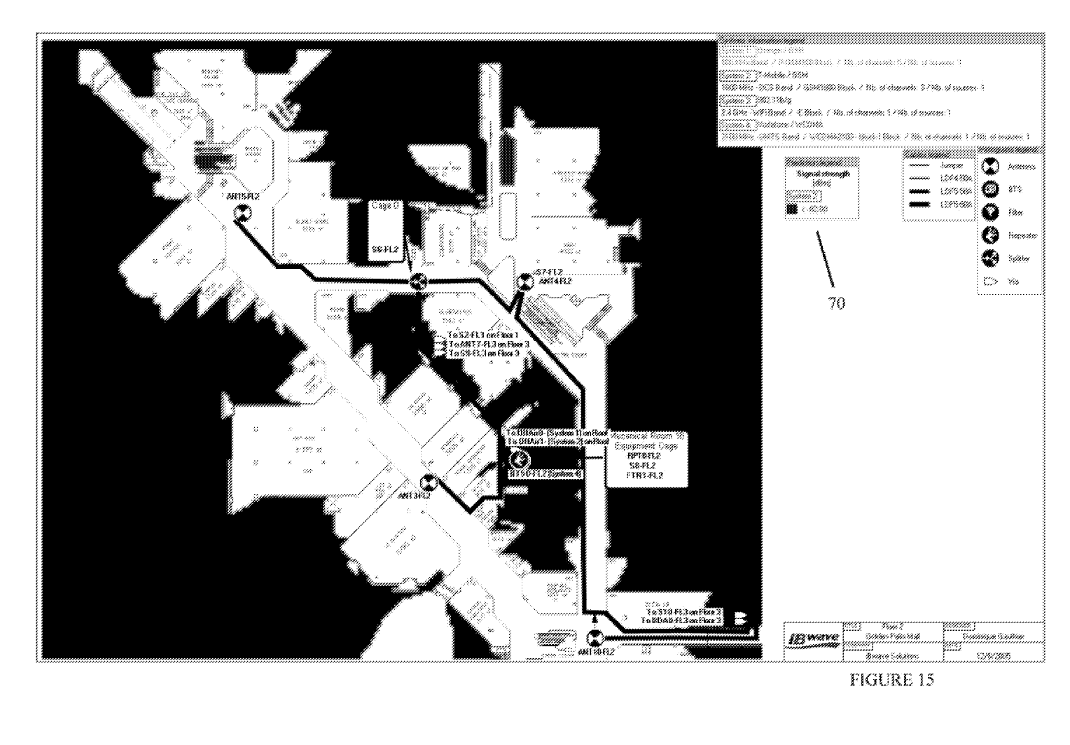

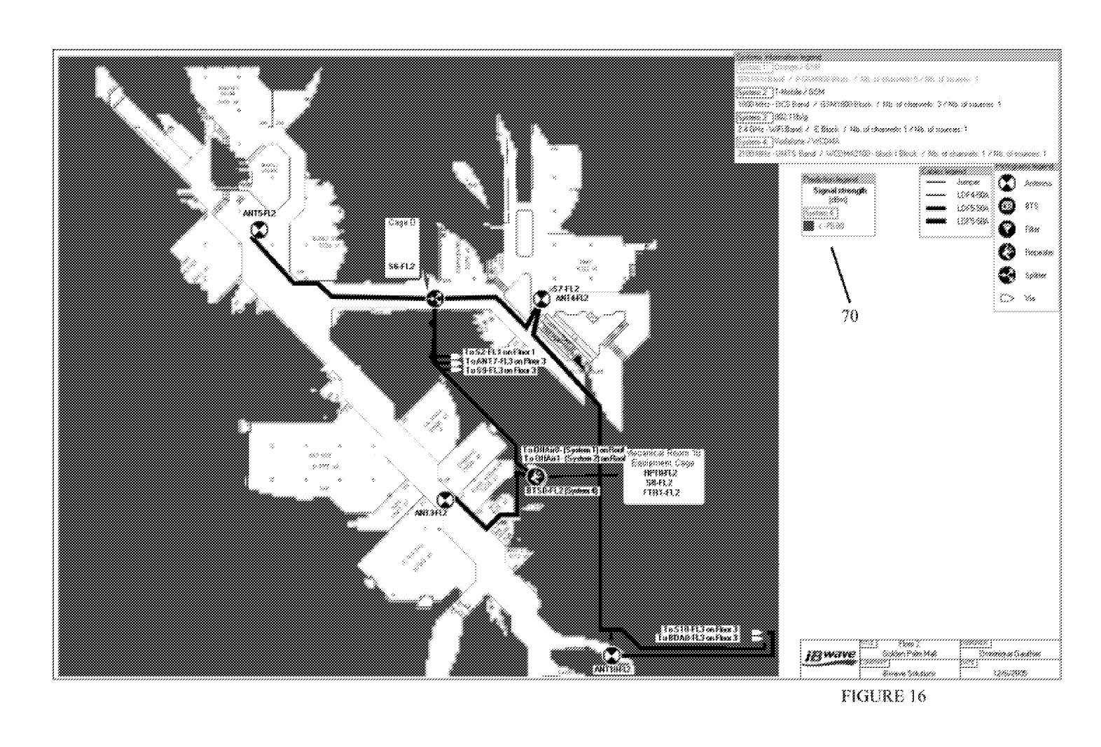

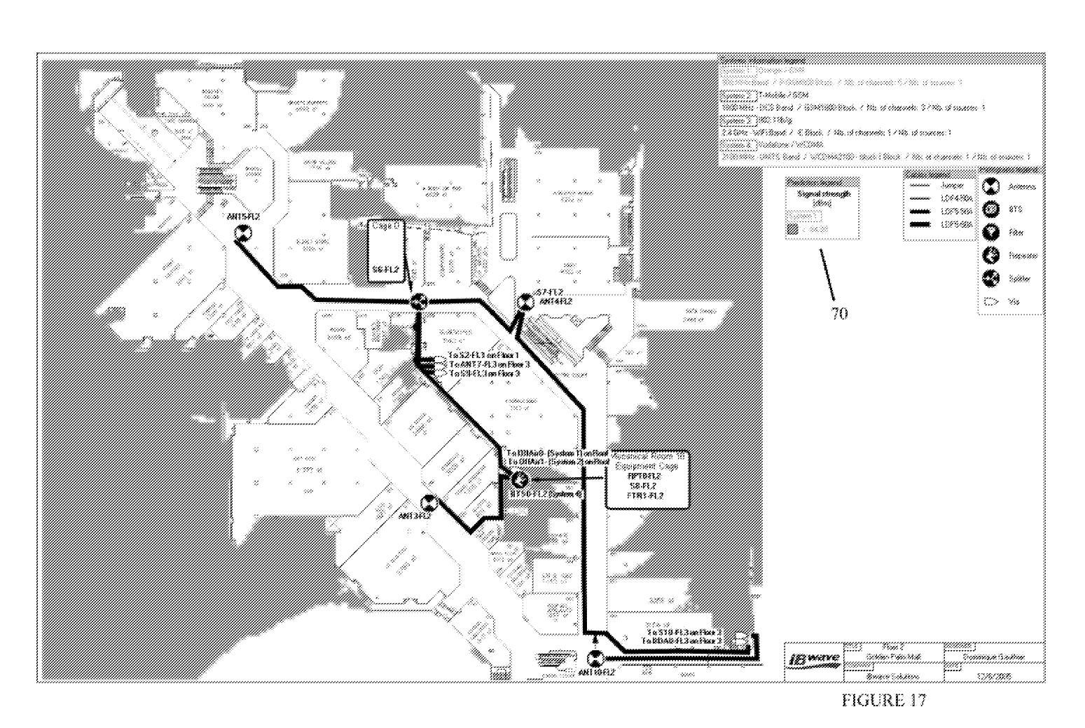

Referring to FIGS. 15 to 17, the estimated signal propagations of three different signal source system 20 are shown. In FIG. 15, the estimated signal propagation of a first signal source system 20 is shown wherein the black area is the area wherein the strength of the estimated signal propagation is below the threshold of −82 dBm as shown by the legend 70. In FIG. 16, the estimated signal propagation of a second signal source system 20 is shown wherein the dark grey is the area wherein the strength of the estimated signal propagation is below the threshold of −75 dBm as shown by the legend 70. Finally, in FIG. 17, the estimated signal propagation of a third signal source system 20 is shown wherein the light grey is the area wherein the strength of the estimated signal propagation is below the threshold of −84 dBm as shown by the legend 70.

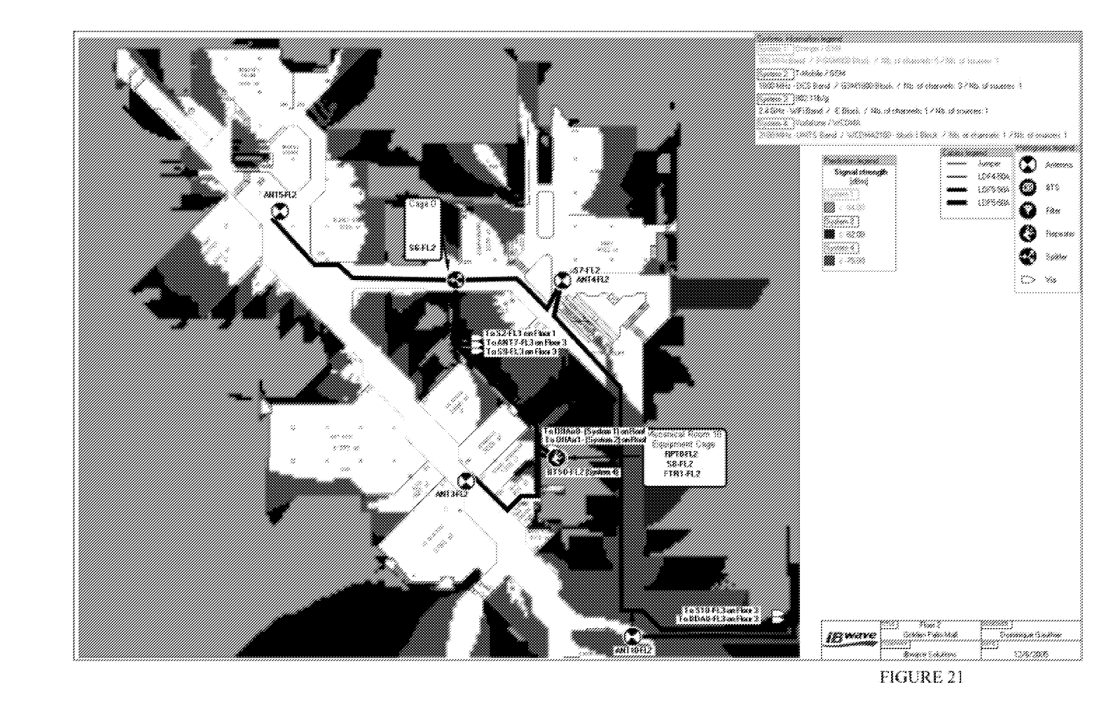

According to the preferred embodiment of the present invention, the estimated signal propagation of all the signal source systems 20 are displayed simultaneously as shown in FIG. 21. In FIG. 21, the estimated signal propagations of the three signal source systems 20 are shown superposed over the floor plan. In this case, the skilled addressee will note that a certain hierarchy exists between the display of the estimated signal propagations. Indeed, the representation of the propagation of the signal of the signal source system 20 whose signals have the best propagation is generally shown on top whereas the representations of the propagation of the signal of the signal source systems 20 whose signals have worse propagation are shown underneath in generally decreasing order of coverage. When the preceding hierarchy is used, the designer will see at first glance which signal source system provides the best coverage.

Understandably, other display schemes are possible. For example, the particular order of display could be chosen by the designer. The present invention is therefore not limited to any particular display order.

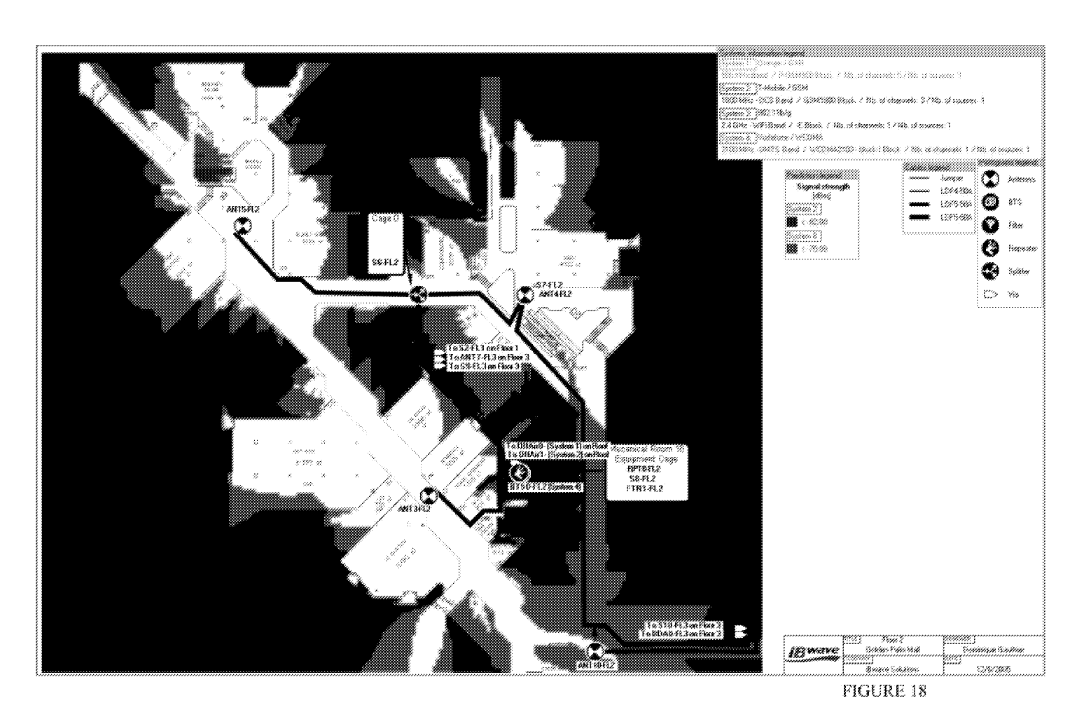

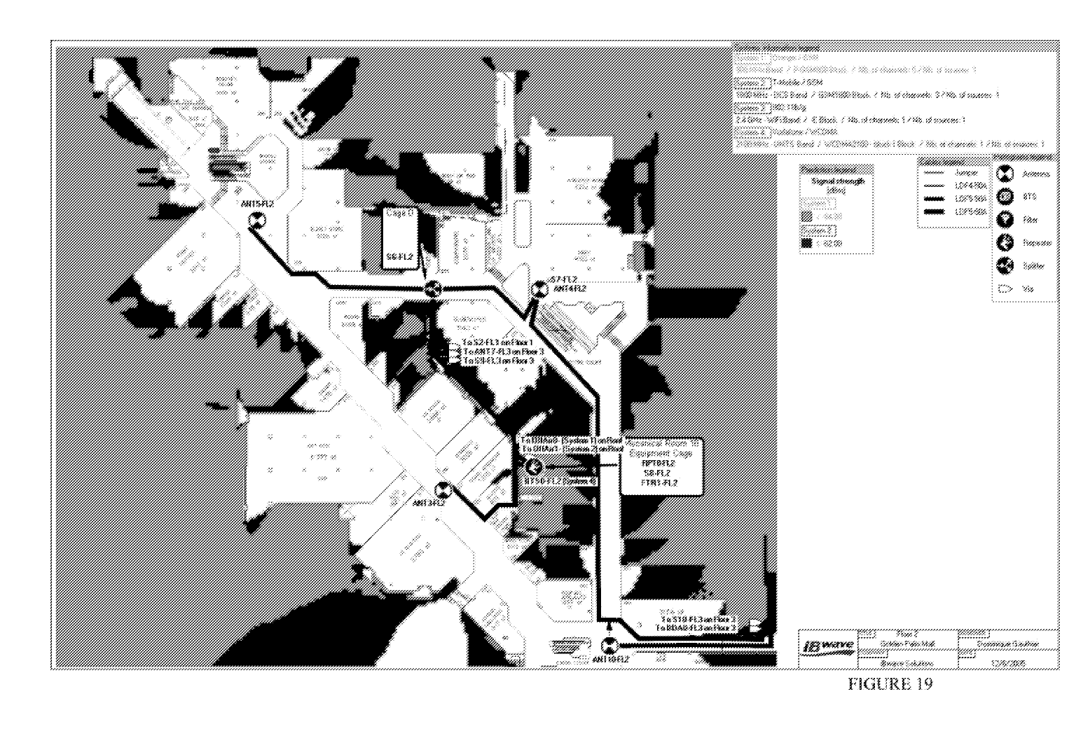

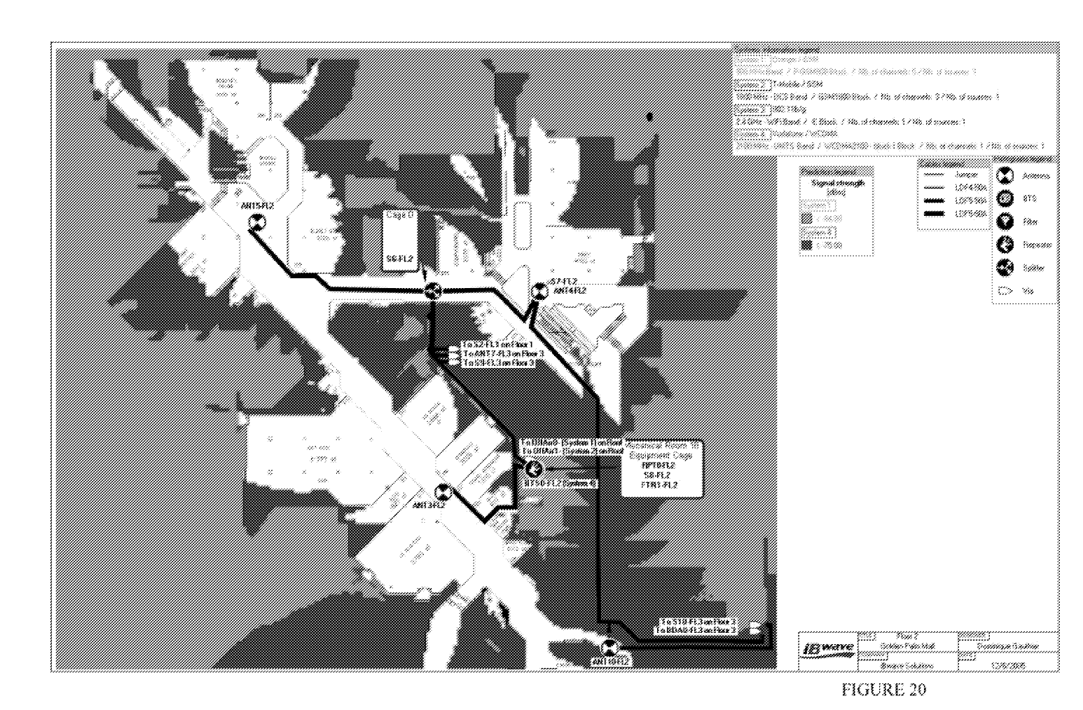

Understandably, the present invention also allows the designer to compare the estimated signal propagations of subsets of signal source systems 20 as shown in FIGS. 18 to 20. More particularly, FIG. 18 displays the superposed estimated signal propagations of the first and second signal source systems 20 of FIGS. 15 and 16. FIG. 19 displays the superposed estimated signal propagations of the first and third signal source systems 20 of FIGS. 15 and 17. Finally, FIG. 20 displays the superposed estimated signal propagations of the second and third signal source systems 20 of FIGS. 16 and 17. Understandably, depending on the number of signal source systems 20, more or less combinations of estimated signal propagations displays would be possible. In any case, the invention preferably allows the designer to toggle on and off the display of any estimated signal propagation.

As the skilled addressee will notice, the present invention allows the designer to see at first glance which, if any, signal source system 20 has an adequate signal propagation in a given physical environment.

Advantageously, the present invention allows the designer to displace directly on the floor plan, one or more components 14 and/or signal source systems 20 and to see the impact of the displacement on the estimated signal propagations. Indeed, the present invention will preferably update all the calculated values when a change is detected in the design.

### Communication Network

Referring now to FIG. 1, the wireless communications network is shown generally at 10 and which is designed according to the method of the present invention. Broadly speaking, the designed network 10 is illustrated as an elevated plan 12. The network 10 includes a number of representations of the network components 14 that are interconnected with a representation of the cabling component 16. The cabling component 16 may be radio frequency (RF), IF (intermediate frequency), twisted pair (CAT5), coaxial cable or optical cable. The wireless communication network 10 may typically be organized to display components on different floors using levels 12 of the building. At each of the network components 14, uplink and downlink link budget calculations 18 are shown in boxes. Two signal source systems 20, 20a each include a transmitter antenna 21a and a receiver antenna 21b. Two numbers 22a and 22b are illustrated with two different calculations (System 20: power/channel, and System 20a: noise/channel) that are defined in a calculation legend 24.

Referring now to FIG. 1a, a network is shown overlaid onto a floor plan of a building. Specifically represented in this illustration are indoor antennae 26, connected by indoor cabling components 28 and 36, a series of splitters 30, a donor antenna 32 and a donor antenna cable 34.

### Operation

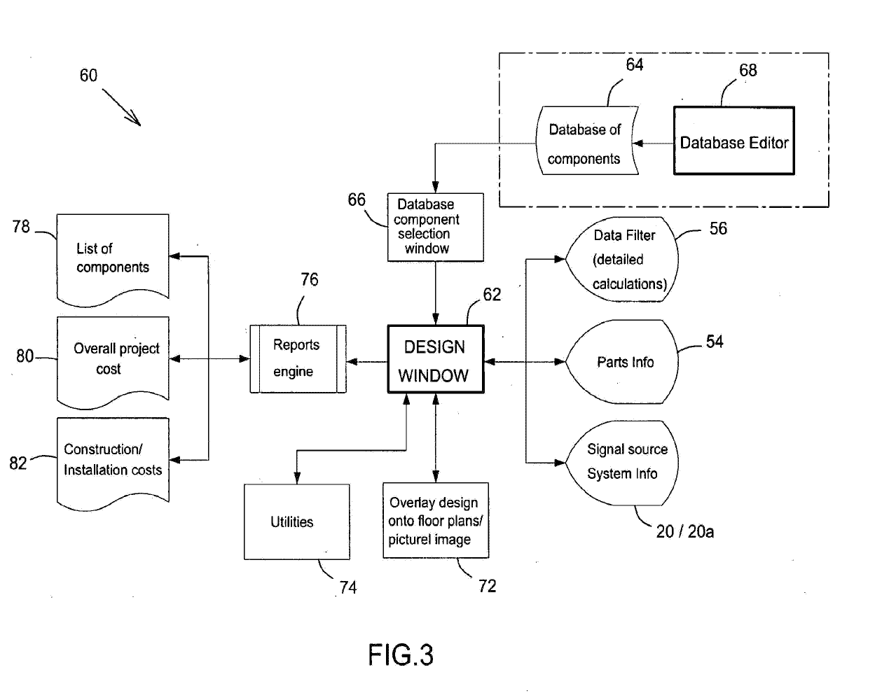

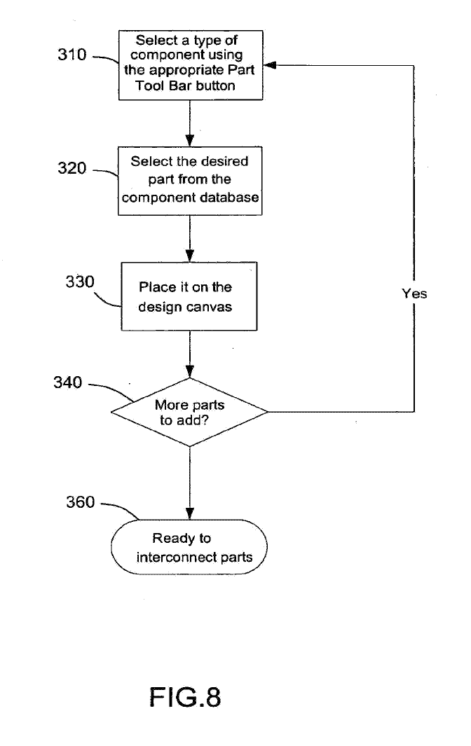

The operation of the software will now be described with reference to the flow diagrams in FIGS. 3, 4, 5, 6, 8, and 11.

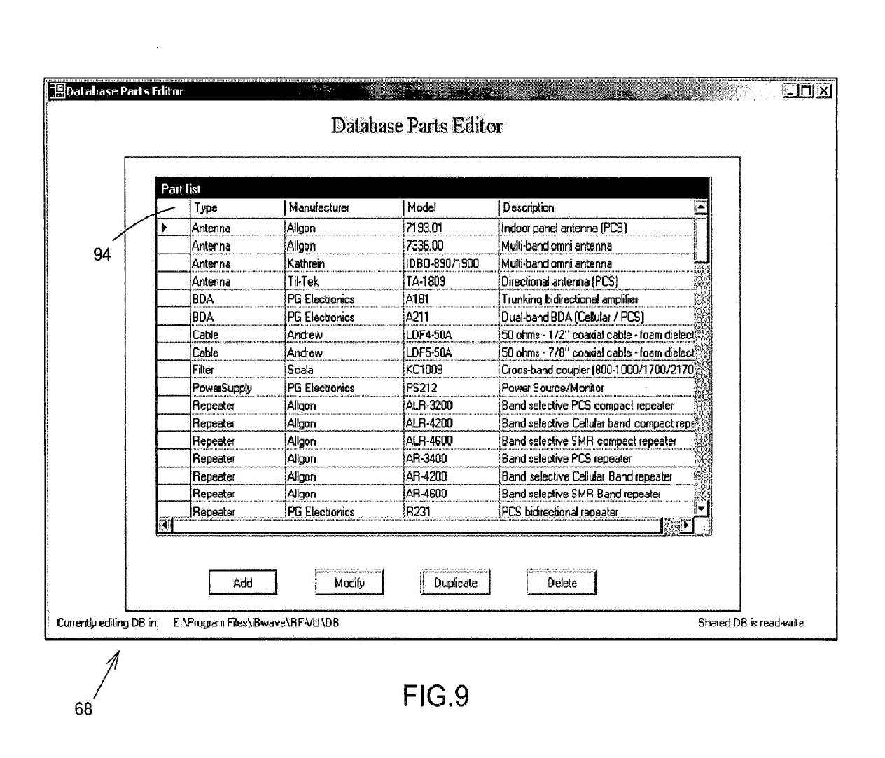

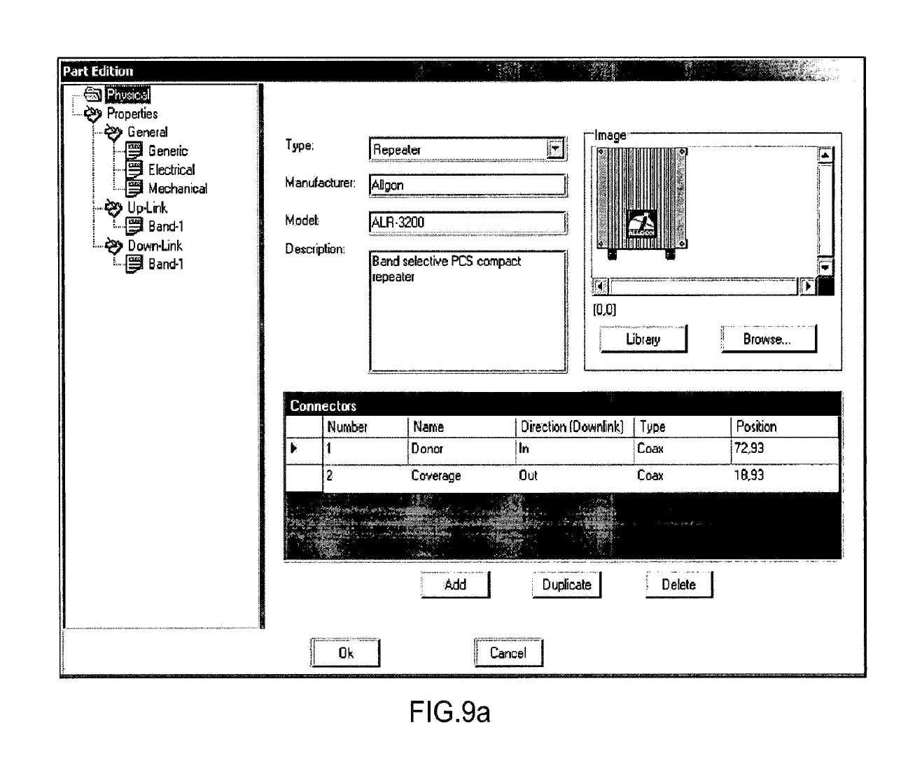

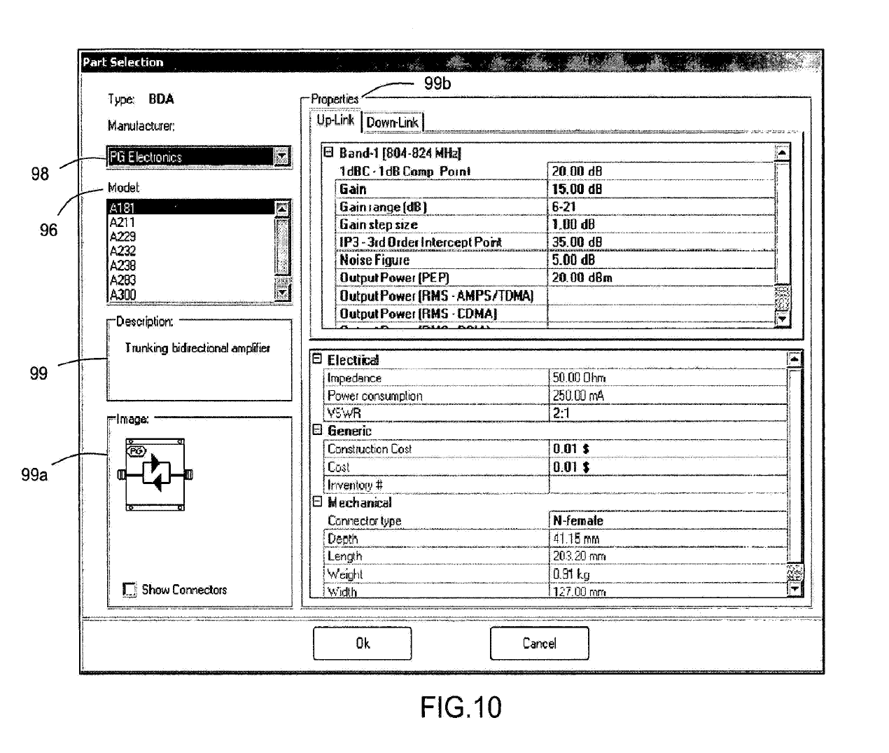

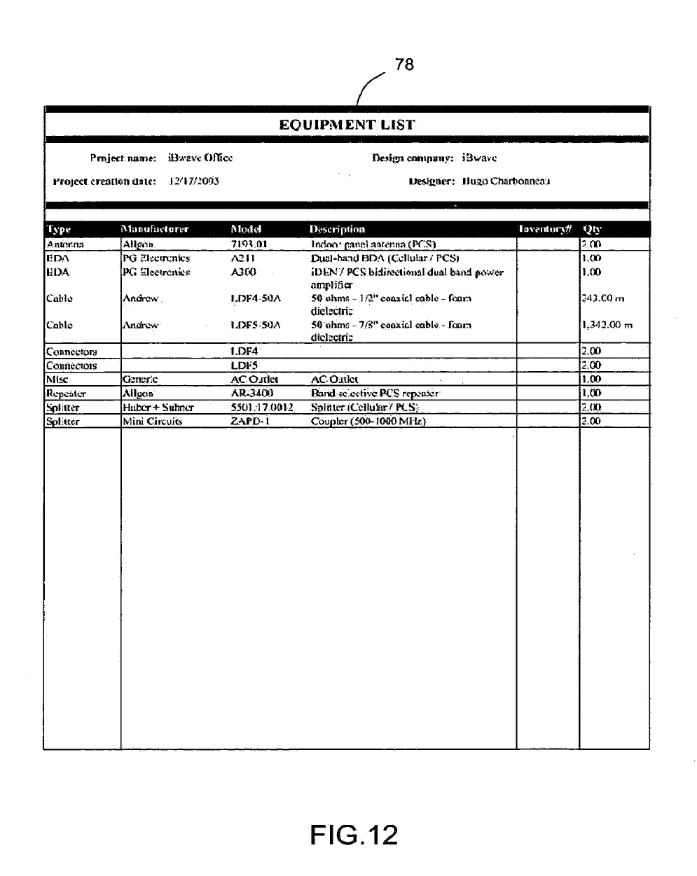

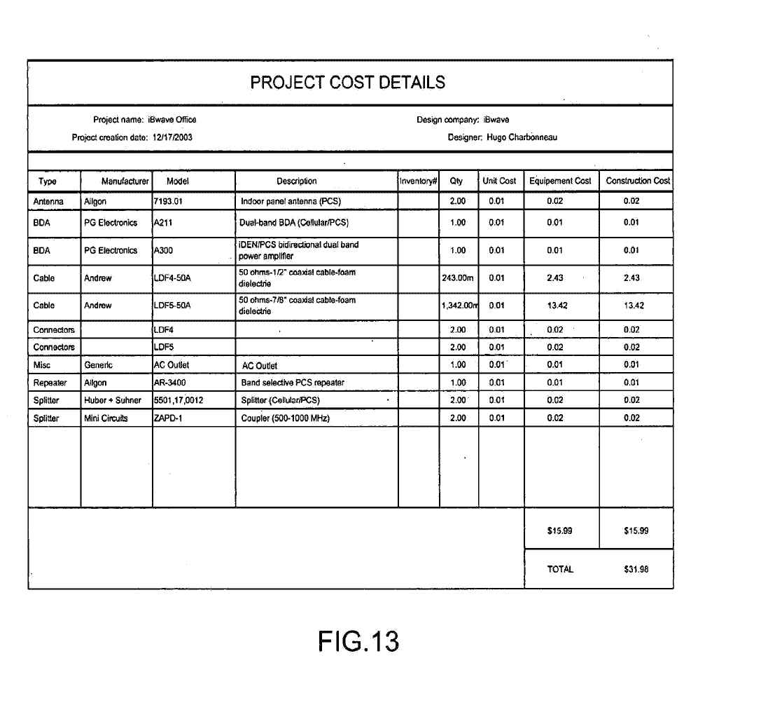

Referring specifically to FIG. 3, there is illustrated a block diagram of a system 60 of the present invention. As described above, the system 60 is typically part of a computer system and includes all of the steps described below in a single, fully integrated package. The system 60 is open architecture so as to expand to include future hardware and software developments. A design window 62 includes the design screen canvas 38 through which a database of components 64 may be accessed. A database selector 66, as illustrated also in FIG. 10, allows the designer to scroll through the database 64 to select a desired component. A database editor 68, as illustrated also in FIGS. 9 and 9a, is an independent software that can be used to modify/add/remove components from the database and includes parts information headings 94. Further, as a sub-part of the design window 62 is the data filter window 56, which performs detailed calculations such as the link budget. The parts information window 54 and the source signal system information window 20, 20a of the multiple systems are also sub-windows of the design window 62. Accessible on the design screen 62 are a utilities window 74 and the ability to generate reports 76 and a design for overlaying onto building floor plans/images or pictures 72. The reports 76 include a list of components (equipment list) 78, an overall cost of the project 80 and construction and/or installation costs (cost report) 82, all of which may be printed out, as seen in FIGS. 12 and 13.

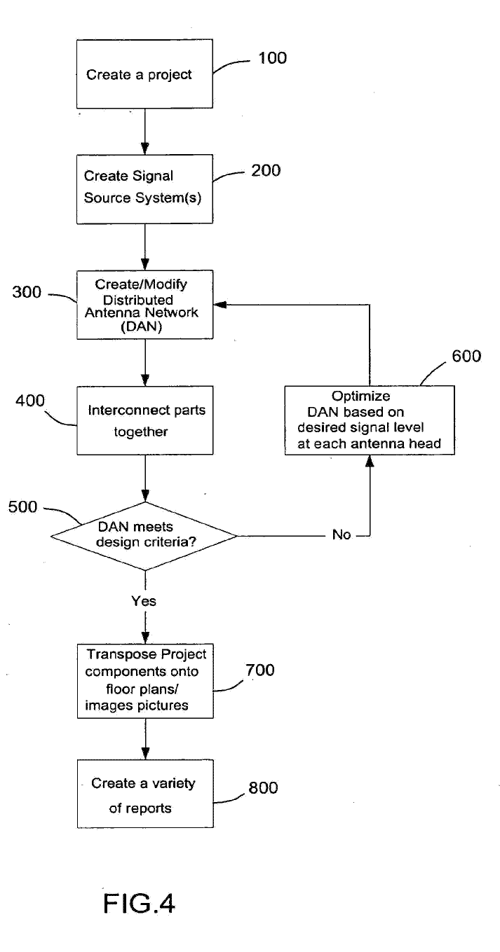

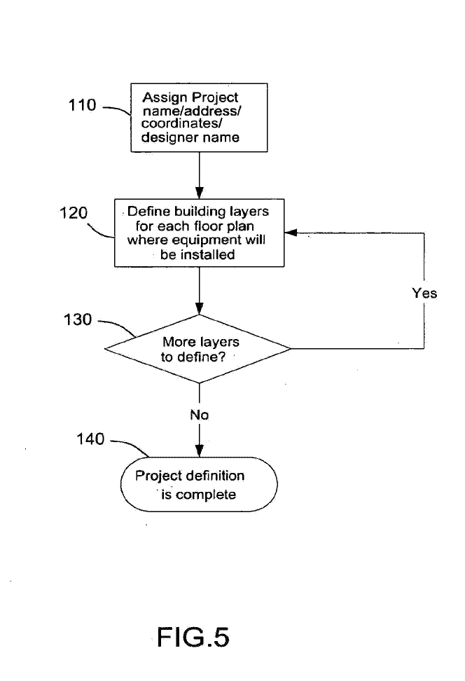

Referring specifically now to FIGS. 4 and 5, in which a flow diagram includes a series of blocks representing a general method of the present invention. Block 100 involves creating a project. On the computer screen, block 110 shows that a designer assigns project parameters such as a project name, company name, address, coordinates and designer name and the like. The designer then, at block 120 defines building layers for each floor plan where the network equipment will be installed by the site technician. Optionally, at block 130, the designer can add more layers and assign additional project parameters. If no other layers are to be added, then the project definition is deemed complete, as shown in block 140. The designer can, at anytime during the DAN design modify the project information and add/delete building layers.

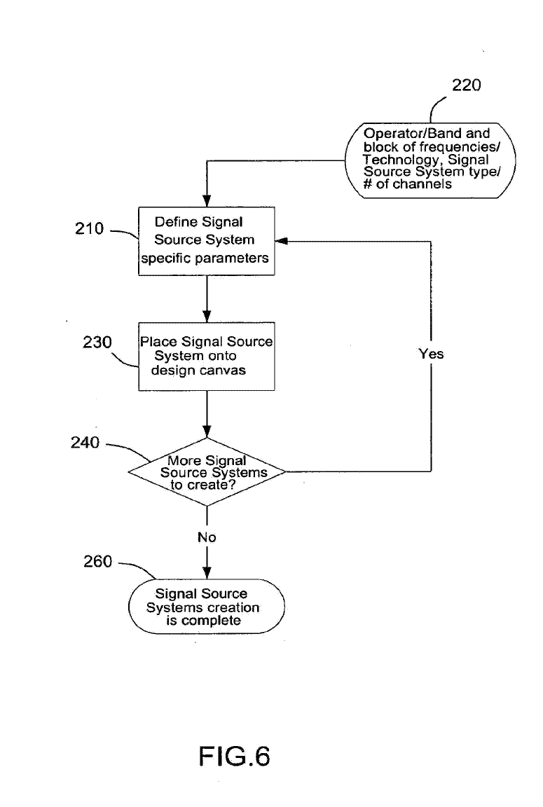

Referring now specifically to FIGS. 4 and 6, after the project has been created at block 100, the designer creates at least one signal source system at block 200. At blocks 210 and 220, the designer, for each of the systems, defines the signal source system specific parameters. After the system parameters have been defined, the designer places the system onto the design screen canvas at block 230. If additional systems are required, at block 240, the designer can repeat the aforesaid steps until the system creation, at block 260, is completed.

Referring now specifically to FIGS. 4, 8, and 10, at block 300, the designer can now create and/or modify a DAN. At block 310, the designer selects a type of system component using an appropriate part tool bar button in a screen window. The window is linked to a components (or parts) database that is located on a computer hard drive or may be downloaded from a local or remote server, such as the Internet. A component is chosen, at block 320, from amongst a list of components using the specific properties of each available component. The screen window of the database includes selection criteria such as part model number 96, manufacturer 98 and brief description 99 and an icon of the component 99a with its properties 99b. The selected components added and then dragged and dropped onto the design screen canvas, using a cursor operated by a pointing device, at block 330. With each of the selected components, connectors are automatically generated by the component's defined location in the database. Every component connectors can be connected using the cabling component 16, which are typically graphical representations of cables. If required, more components can be added from the database and placed on the design screen canvas, at block 340 and the process repeated until the designer is ready to interconnect the system components at block 360 to produce a graphical representation of the DAN.

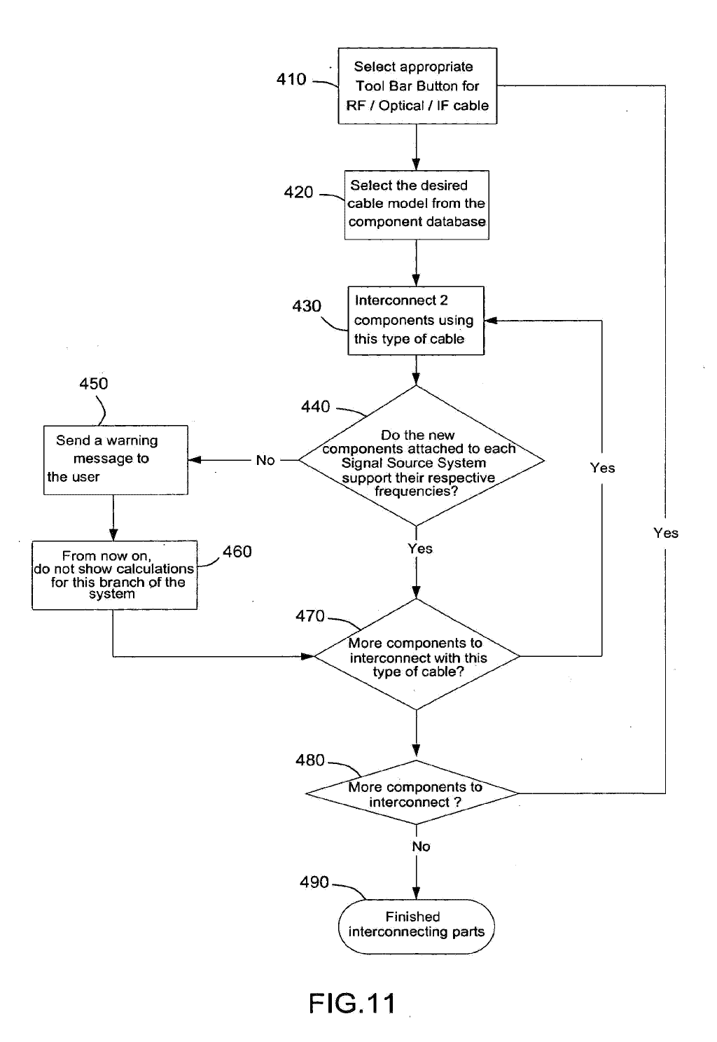

Referring now specifically to FIGS. 4 and 11, following creation and placing of the on screen components at block 300, the designer can now interconnect the system components at block 400.

At block 410, the designer selects the appropriate tool bar button for RF/Optical/IF/twisted pair cable and thereafter, at block 420, selects the desired cabling component model from the components database. The cabling component 16 is a line representing the cable on the canvas. The connector is the location on the component where the cabling component connects. The connectors are automatically generated for a component from the information in the database.

At this point at block 430, the designer interconnects, using the aforesaid selected cable model, at least two of the selected system components by dragging and dropping the representation of the components on the design screen canvas. At block 440, the designer performs a compatibility verification step to ensure that each of the connected components support the systems parameters connected as its signal source as described above. If the connected components are incompatible, at block 450, the warning message (In the debug window) 50, as shown in FIG. 2, alerts the designer to adjust the components or to replace them to reach a desired level of signal for each antenna and ensure component's compatibility with the systems. The warning message alerts the designer that the interconnected components require debugging and modification. Link budget calculations at each of the system components, at block 460, are not displayed until the compatibility is verified, otherwise the designer moves on to block 470.

If the system components are compatible using the type of cable model, the designer moves from block 440 to block 470 with the option to add additional components and to check and verify their compatibility at block 480. If the designer has no more components to interconnect, the designer moves from block 480 to block 490. The calculation data displays link budget, from wireless device to signal source system, information to make sure sensitivity degradation of the system source is kept to a minimum and meets user-defined objective. Once the compatibility of the system components have been validated, the link budget calculations are performed at each of the connected components, as illustrated by the screen windows shown in FIGS. 1 and 2.

Referring now to FIG. 4, once the component parts are connected together, the designer makes the decision at block 500 whether the system meets the design criteria. If the system does not meet the criteria, the designer must, at block 600, optimize the systems based on the desired signal level of each antenna head by repeating the process starting at block 300 by modifying the components and/or interconnections. If the design is acceptable, at block 700 the DAN is ready to be overlaid or transposed onto a variety of installation plans.

Referring now to FIGS. 3, 4, 12 and 13, block 800 includes the step for generating design reports. The designer can now print the design laid onto the design canvas, print the floor plan layouts with components, obtain and print a list of components with associated costs if desired, obtain and print a construction/installation cost evaluation of its project. A site technician can also print installation plans for use in constructing the network. The topology of the system can be overlaid on building floor plans to ease the site technician's task with locating individual system components throughout the building. Components overlaid over picture or image can also be printed for the technician to specify the exact location of components with pictures. In FIG. 12, a screenshot of an equipment list includes information such as project name, designer name and project creation date across the upper part of the screen. Columns of equipment information include equipment type, manufacturer, model number, description and quantity. Additional columns may be added such as inventory number. Referring now to FIG. 13, a screenshot of a cost report, which includes tabulated information in columns of quantities, unit cost, equipment cost and construction cost information for all the components of the network. The cost report calculates the total cost of the equipment and the total cost of the construction of the network.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A computer-implemented method for creating a distributed antenna network for use in designing a wireless communications network, the method comprising:
on a design screen canvas provided on a display screen connected to a computer system, placing multiple signal source systems selected from a signal sources database stored in said computer system, each of said signal source systems having a source of signal and a plurality of specified system parameters;
on said design screen canvas, placing multiple components selected from a components database stored in said computer system;
on said design screen canvas, interconnecting said signal source systems with said components;
validating the compatibility of the connections between components and said signal source systems;
transposing said distributed antenna network onto a floor plan;
for each of said signal source systems, calculating an estimated area of coverage;
on said floor plan and for each of said signal source systems, displaying said estimated area of coverage, each said areas of coverage being displayed so as to be distinguishable from each other.

2. The method, according to claim 1, wherein at least two of said signal source systems have different sources of signal and/or different system parameters.

3. The method, according to claim 1, wherein each estimated area of coverage of each of said signal source system is assigned a different colour.

4. The method, according to claim 1, wherein each estimated area of coverage of each of said signal source system is assigned a different symbol.

5. The method, according to claim 1, further comprising the step of hiding one or more displayed estimated areas of coverage.

6. The method, according to claim 1, wherein said estimated areas of coverage are displayed according to a hierarchy.

7. The method, according to claim 1, wherein said estimated areas of coverage are displayed in decreasing order with respect to the size of said area of coverage.

8. The method, according to claim 1, in which the components database is accessible from the design screen canvas, the component being selected based on the specified system parameters.

9. The method, according to claim 1, in which the component is selected from a list of available components based on specific properties of each of the available components.

10. The method, according to claim 1, in which the signal source system includes a signal source, a technology, a band of frequencies and a block of frequencies.

11. The method, according to claim 1, further includes:
selecting a cabling component from the components database;
representing the selected cabling component on the design screen canvas; and
interconnecting the selected components using the selected cabling component.

12. The method, according to claim 1, in which the selected components are interconnected on the screen design canvas using an on-screen pointing device implemented drag-and-drop technique.

13. The method, according to claim 1, in which a debug window is displayed on the design screen canvas, the debug window displaying debug window messages when the interconnected components are incompatible.

14. The method, according to claim 1, further includes transposing the interconnected components onto at least one installation plan of the wireless communications network.

15. The method, according to claim 1, in which the wireless communications network is located within a building.

16. The method, according to claim 1, in which the wireless communication network is located outside of a building.

17. The method, according to claim 1, in which the design screen canvas is a graphical representation of the wireless communications network.
